(19) United States
(12) Patent Application Publication
(10) Pub. No.: US 2014/0158720 A1
(43) Pub. Date: Jun. 12, 2014

(54) Weighted Bob for a Dispensing Tube

(71) Applicant: Daryl J. Lansky, Memphis, TN (US)

(72) Inventor: Daryl J. Lansky, Memphis, TN (US)

(21) Appl. No.: 13/712,917

(22) Filed: Dec. 12, 2012

(51) Int. Cl. B67D 7/78

(52) U.S. Cl. CPC B05B 11/0059
USPC 222/464.4

(57) ABSTRACT

A weighted bob adapted for being attached proximate a distal or intake end of a dispensing tube of a handheld dispenser of liquid. The bob can be provided separately for use with prior art dispensers, or the bob can be provided with the dispenser. As the dispenser is tilted to different angles, gravity acting on the weighted bob causes the intake end of the tube to remain submerged in liquid held inside a vessel's void within the dispenser.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to dispensers for liquid, and, in particular, to hand-held liquid dispensers.

2. Information Disclosure Statement

Hand-held sprayers and liquid dispensers are well known, and typically have a body or vessel having a void thereinside filled with a liquid, such as, for example, a cleaning compound, to be dispensed. A pump or actuator is typically provided atop a neck of the vessel, and a tube extends from the pump or actuator, into the vessel's void and into the liquid inside the vessel's void. A problem with prior art dispensers is that, while they work well if held perfectly upright, when the dispenser is tilted in order to reach hard-to-access places, such as when a cleaner is sprayed under a shelf or into a corner, the distal end of the tube no longer remains submerged within the liquid as the liquid moves within the vessel in response to the tilting of the dispenser. When the distal end of the tube is no longer submerged in the liquid, the dispenser becomes ineffective.

It is therefore desirable to have an improved hand-held dispenser for liquid that can be used at various angles of orientation.

### BRIEF SUMMARY OF THE INVENTION

The present invention is a weighted bob adapted for being attached proximate a distal or intake end of a dispensing tube of a handheld dispenser of liquid. The bob can be provided separately for use with prior art dispensers, or the bob can be provided with the dispenser. As the dispenser is tilted to different angles, gravity acting on the weighted bob causes the intake end of the tube to remain submerged in liquid held inside a vessel's void within the dispenser.

It is an object of the present invention to provide an improved hand-held dispenser for liquid that can be used at various angles of orientation.

### BRIEF DESCRIPTION OF THE SEVERAL VIEWS OF THE DRAWING

FIG. 1 is a perspective partial sectional view of the weighted bob of the present invention attached to an end of a tube of a handheld liquid spray dispenser, which is shown in a substantially upright orientation.

FIG. 2 is a perspective partial sectional view of the weighted bob of the present invention attached to an end of a tube of a handheld liquid spray dispenser, similar to FIG. 1 but showing the dispenser in an angled spraying orientation for spraying in an upward direction.

FIG. 3 is a transverse sectional view of the weighted bob of the present invention attached to a tube, taken substantially along the line 3-3 shown in FIG. 1.

FIG. 4 is a side view showing two weighted bobs of the present invention attached to a tube of a dispenser, showing an alternate attachment of the bob using a brad or pin.

FIG. 5 is a side view of the weighted bob of the present invention attached to a tube using a bead of glue or welding.

FIG. 6 is a sectional view of the weighted bob of the present invention shown received within the passageway of a tube.

### DETAILED DESCRIPTION OF THE INVENTION

Referring to the drawing figures, the present invention is a weighted bob 20 in combination with a handheld dispenser 22. Dispenser 22 is well known and includes a body or vessel 24 having a void 26 thereinside. Contained within void 26 is a liquid 28 that is dispensed by dispenser 22, with liquid 28 having a first specific gravity.

Dispenser 22 includes a well-known dispensing head 30, such as a well-known spray head including a nozzle 32 and an actuator or lever 34 pivotally mounted to dispensing head 30 such that actuation of lever 34 dispensingly pumps liquid 28 out of nozzle 32 in a manner well known to those skilled in the art. It should be understood that the present invention may be used equally well when the dispensing head 30, rather than having a manual pump, may have an electric motor to pumpingly dispense liquid 28.

Dispenser 22 further includes a well-known flexible tube 36, with tube 36 having a first end 38 in communication with dispensing head 30 and having a second or intake end 40 extending within void 26 and in submerged communication with liquid 28. Liquid 28 is understood to pass through tube 36 from second end 40 to the dispensing head 30 in a manner well known to those skilled in the art.

Weighted bob 20 is attached to tube 36 remote from first end 38 and preferably proximate second end 40 of tube 36. Bob 20 has a bore 42 therethrough, with a portion 43 of tube 36 preferably being frictionally received through close-fitting bore 42 and with bob 20 being frictionally retained on tube 36 as by the frictional forces between tube 36 and bore 42. Alternatively, bob 20 may be welded or glued to tube 36, as by providing a bead 44 of melted plastic or glue as shown in FIG. 5, or providing a transverse pin or brad 46 through bob 20 and tube 36 as shown in FIG. 4, so as to retain bob 20 on tube 36, and the end 48 of the pin may be bent as shown in FIG. 4 to retain the pin through the bob 20. Alternatively, it should be understood that bob 20 may be integrally molded with tube 36 so as to be a part of tube 36 proximate second end 40.

Vessel 24 typically has a neck 50, with neck 50 having a constricted inner neck diameter 52 and with dispensing head 30 being joined to vessel 24 atop neck 50 as by a well-known screw-on fitting 54. Bob 20 preferably has an outer bob diameter 56 that is smaller than inner neck diameter 52 so that bob 20 may pass easily into void 26 through neck 50 as dispensing head 30 is received onto vessel 24 and attached thereto by fitting 54.

Bob 20 has a second specific gravity that is substantially greater than the first specific gravity of liquid 28. If tube 36 is not highly flexible, it shall be understood that the weight of bob 20 may be increased to provide additional force on the second end 40 of tube 36 due to gravity acting on bob 20 so as to keep the end 40 submerged in the liquid 28 when dispenser 22 is tilted, as shown in FIG. 2.

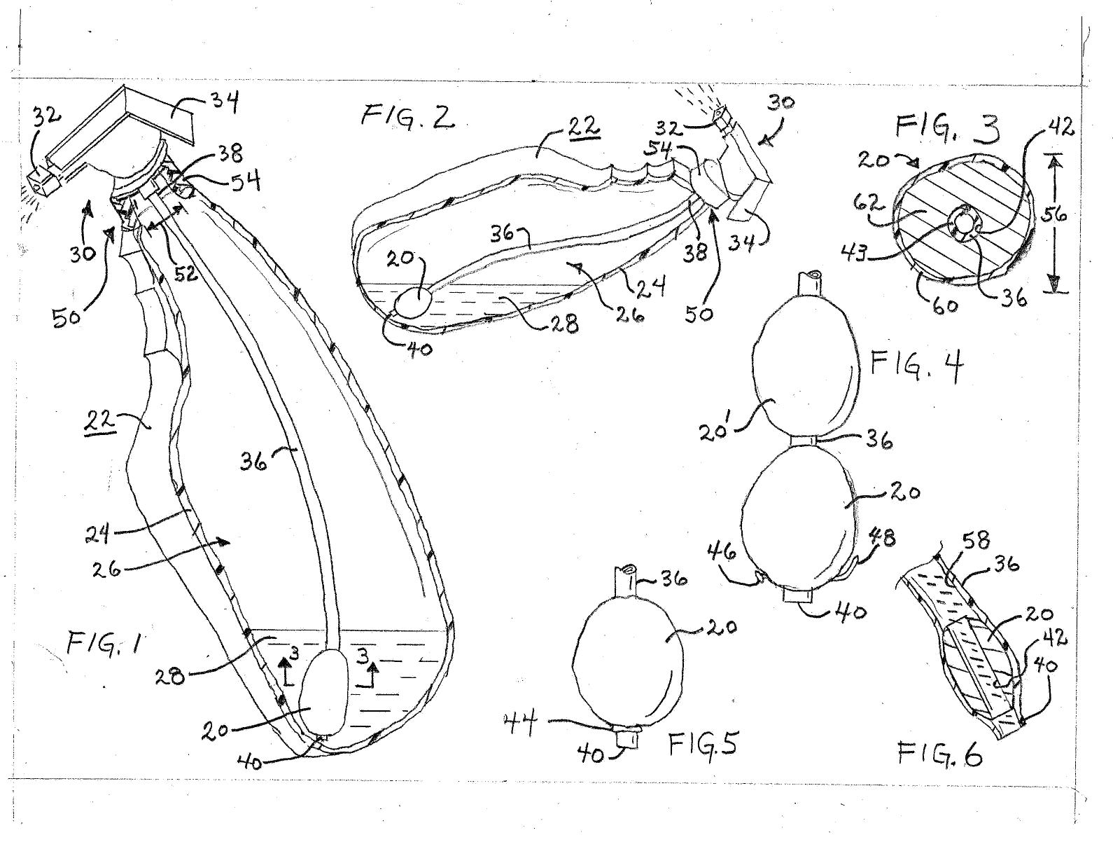

To enable prior art dispensers 22 to be used with the bob 20 of the present invention, bob 20 may be provided separately from dispenser 22 and then be frictionally received onto second end 40 of tube 36 as shown in FIGS. 1, 2, and 3, or frictionally received within the passageway 58 of tube 36 as shown in FIG. 6.

It should be understood that a plurality of bobs, such as bobs 20 and 20′ as shown in FIG. 4, may be provided so as to increase the weighting provided on tube 36 without increasing the outer bob diameter, also allowing for a single bob to be used in situations where lesser weighting may be needed.

Referring to FIG. 6, an alternate manner of attaching bob 20 to tube 36 is shown. Rather than having tube 36 being received through bore 42, instead bob 20 may be frictionally received within the passageway 58 of tube 36, with tube 36 being stretched to retain bob 20 therewithin, and, in such a combination, the liquid 28 will pass upwardly into the tube 36 through bore 42 that is through bob 20.

Bob 20 may be made of a variety of materials suitable for immersion in liquid 28. For example, bob 20 may be made of lead or ceramic clay, and, if desired, bob 20 may be provided with a shell or covering 60 such as plastic so that the weighed core 62 is not exposed to the liquid 28 within dispenser 22. It has been experimentally found that a bob weight of approximately 0.5 ounce (14 grams) is a satisfactory weight for use with a standard flexible tube 36 that is 10 inches (25 cm.) long as often found in spray dispensers for glass cleaning preparations.

To adapt a prior art dispenser 22 to use the weighted bob 20 of the present invention, the tube 36 is removed from within the dispenser 22 as by unscrewing fitting 54. The bob 20 is then fitted onto the second end 40 of tube 36 and the fitted bob 20 is then inserted through the neck 50 of the vessel and down into the liquid 28, and the dispensing head 30 is again secured onto fitting 54. As the dispenser 22 becomes tilted during use, the weighted bob 20 will cause tube 30 to flex and second end 40 will tend to remain submerged in the liquid 28.

### INDUSTRIAL APPLICABILITY

The bob of the present invention permits a handheld dispenser for dispensing liquid to be used in a variety of angles and orientations, and keeps the intake end of a flexible tube within, and in communication with, liquid inside a void within the dispenser.

Although the present invention has been described and illustrated with respect to a preferred embodiment and a preferred use therefor, it is not to be so limited since modifications and changes can be made therein which are within the full intended scope of the invention.

I claim:

1. In combination:
(a) a dispenser for dispensing a liquid, said dispenser comprising:
i. a vessel having a void thereinside, said void containing said liquid, said liquid having a first specific gravity;
ii. a dispensing head for dispensing said liquid; and
iii. a flexible tube having a first end in communication with said dispensing head and having a second end extending within said void and in communication with said liquid; and
(b) a bob attached to said flexible tube remote from said first end, said bob having a second specific gravity greater than said first specific gravity.

2. The combination as recited in claim 1, in which said bob is attached to said flexible tube proximate said second end.

3. The combination as recited in claim 2, said vessel having a neck, said neck having an inner neck diameter; said dispensing head being joined to said vessel atop said neck; said bob having an outer bob diameter that is smaller than said inner neck diameter.

4. The combination as recited in claim 2, in which said bob has a bore therethrough with a portion of said tube being within said bore.

5. The combination as recited in claim 2, in which said bob has a bore therethrough and said tube has a passageway therewithin, and said bob is received within said passageway in said tube.

6. The combination as recited in claim 1, said vessel having a neck, said neck having an inner neck diameter; said dispensing head being joined to said vessel atop said neck; said bob having an outer bob diameter that is smaller than said inner neck diameter.

7. A bob adapted for attachment remote from a first end of a flexible tube of a dispenser for dispensing a liquid, said dispenser comprising:
(a) a vessel having a void thereinside, said void containing said liquid, said liquid having a first specific gravity; and
(b) a dispensing head for dispensing said liquid;
said first end of said flexible tube being in communication with said dispensing head and said flexible tube having a second end extending within said void and in communication with said liquid;
said bob having a second specific gravity greater than said first specific gravity.

8. The bob as recited in claim 7, said vessel having a neck, said neck having an inner neck diameter; said dispensing head being joined to said vessel atop said neck; said bob having an outer bob diameter that is smaller than said inner neck diameter.
